(19) United States
(12) Patent Application Publication
(10) Pub. No.: US 2025/0228389 A1
(43) Pub. Date: Jul. 17, 2025

(54) MILK-FROTHING ACCESSORY FOR COFFEE MACHINES

(71) Applicant: Cuinan Zeng, Foshan (CN)

(72) Inventor: Cuinan Zeng, Foshan (CN)

(21) Appl. No.: 18/634,684

(22) Filed: Apr. 12, 2024

(30) Foreign Application Priority Data
Jan. 11, 2024 (CN) 202410045607.5

(51) Int. Cl. A47J 31/44; A47J 31/41

(52) U.S. Cl. CPC A47J 31/4489; A47J 31/41; A47J 31/4485

(57) ABSTRACT

The present invention discloses a milk-frothing accessory for coffee machines, comprising: a main body and a milk feeding tube, wherein the main body has a main passage, a milk passage and an air passage; a steam inlet and a milk-froth outlet are respectively set on the two ends of the main passage, of the milk passage arranged on one side of the main passage, one end communicates with the blending chamber, and the other end is provided with a milk feeding opening connected with the milk feeding tube; of the air passage arranged on one side of the milk passage, one end communicate with the milk passage, the other end is provided with an air inlet. In the present invention, the milk-frothing accessory is applied in the coffee machine with steam pipes, so that the machine can not only heat milk, but also make milk-froth.

### CROSS-REFERENCE TO RELATED APPLICATIONS

This application claims priority of Chinese Patent Application No. 202410045607.5, filed on Jan. 11, 2024, the entire contents of which are incorporated herein by reference.

### FIELD OF THE INVENTION

The present invention relates to the technical field of beverage preparation, in particular to a milk-frothing accessory for coffee machines.

### BACKGROUND OF THE INVENTION

Coffee blended with milk and milk-froth is a delicious beverage, therefore widely loved by consumers, thus many coffee machine manufacturers consider adding a milk-heating function or designing a milk-frothing generator on a pressure coffee machine. At present, a kind of machines equipped with output steam pipes are common on the market, wherein the steam pipe of this machine is mainly used to output steam to heat milk, but this machine does not have a direct milk-frothing function.

There are another kind of coffee machines equipped with milk-frothing generators, for example, a beverage machine and a milk-frothing device thereof disclosed in CN202123282922.0, but the milk-frothing device cannot be used on the machine equipped with a steam pipe.

### SUMMARY OF THE INVENTION

The objective of the present invention is to provide a milk-frothing accessory for coffee machines, which can equip a coffee machine with a steam output pipe, so that the machine can not only heat milk, but also make milk-froth, thereby overcoming the deficiencies of the prior art.

The present invention adopt the following technical scheme and provides a milk-frothing accessory for coffee machines, comprising: a main body and a milk feeding tube, wherein the main body has a main passage, a milk passage and an air passage;
a steam inlet and a milk-froth outlet are respectively set on the two ends of the main passage, and a blending chamber used to blend steam, milk and air and a frothing chamber used to release slowly milk-froth are further set inside the main passage;
of the milk passage, one end communicates with the blending chamber, and the other end is provided with a milk feeding opening connected with the milk feeding tube;
of the air passage, one end communicates with the milk passage, and the other end is provided with an air inlet; a deceleration chamber used to slow down the flow rate of incoming air is further set in the air passage; a receiving ring is arranged between the blending chamber and the frothing chamber, and the receiving ring is embedded in a first groove of the main passage and provided with a first through hole that communicates the blending chamber with the frothing chamber;
a center of the frothing chamber relative to the blending chamber is set to be eccentric, and a notch that communicates a the milk-froth outlet channel is opened on a side wall of the frothing chamber and located on the side wall of the frothing chamber close to a centerline of the blending chamber.

The first through hole is funnel-shaped.

The steam inlet is provided with a steam spray nozzle,
the top end of the steam spray nozzle is exposed outside the steam inlet and is used to connecting an external steam passage;
the bottom of the steam spray nozzle is embedded in a second groove of the main passage, the bottom of the steam spray nozzle is a tapered portion, a steam hole that communicates with the blending chamber is opened on the bottom of the tapered portion, and the side wall of the tapered portion faces the outlet of the milk passage communicating with the blending chamber;
a milk ring is set at the end of the milk passage leading to the blending chamber, and the milk ring is provided with a funnel-shaped second through hole that communicates the milk passage with the blending chamber.

The air inlet is provided with an air cap, which is embedded in a third groove on the inner wall of the air passage; the deceleration chamber is positioned in the air passage below the bottom of the air cap, and a connecting hole is set between any two among the air cap, the deceleration chamber and the milk passage.

The top of the air cap is exposed at the air inlet, a ventilation piece is embedded in a fourth groove on the inner wall of the top of the air cap, and an air inlet hole is opened on the ventilation piece.

The milk feeding tube includes a joint and a milk-taking head, the joint is connected with the milk feeding opening, and an elastic connecting pipe is arranged between the joint and the milk-taking head.

The main body and the air cap are made of silicone, and the receiving ring, the steam spray nozzle, the milk ring and the ventilation piece are made of stainless steel.

A coffee machine comprising the milk-frothing accessory.

The main passage and the air passage each have a cylindrical outer wall, which intersects with another, and of which the center line is parallel to that of another, an extremity of the milk-froth outlet channel extends out from the cylindrical outer wall of the main passage to form a cylinder body having an outer diameter smaller than the diameter of the cylindrical outer wall of the main passage, the milk passage also has a cylindrical outer wall, which perpendicularly intersects with the cylindrical outer wall of the air passage, the centerlines of these three cylindrical outer walls are located on a first plane, and the centerline of the cylinder body is parallel to the first plane.

### BRIEF DESCRIPTION OF THE DRAWINGS

FIG. 1 is a structure diagram of the milk-frothing accessory of the present invention.

FIG. 2 is an exploded view of the milk-frothing accessory of the present invention.

FIG. 3 is a front cross-sectional view of the main body of the milk-frothing accessory of the present invention.

FIG. 4 is a side view of the milk-frothing accessory of the present invention.

FIG. 5 is a side cross-sectional view of the main body of the milk-frothing accessory of the present invention.

FIG. 6 is an exploded view of the main body of the milk-frothing accessory of the present invention.

FIG. 7 is an enlarged view at A in FIG. 3.

FIG. 8 is a diagram of the coffee machine using the milk-frothing accessory of the present invention.

### DETAILED DESCRIPTION OF SOME EMBODIMENTS

The technical solutions in the embodiments of the present invention will be clearly and completely described as follows in combination with the drawings in the examples of the present invention, but obviously, the described examples are only a part of the embodiments of the present invention. Based on the examples of the present invention, all other examples obtained by a person skilled in the art without creative efforts shall fall within the protection scope of the present invention.

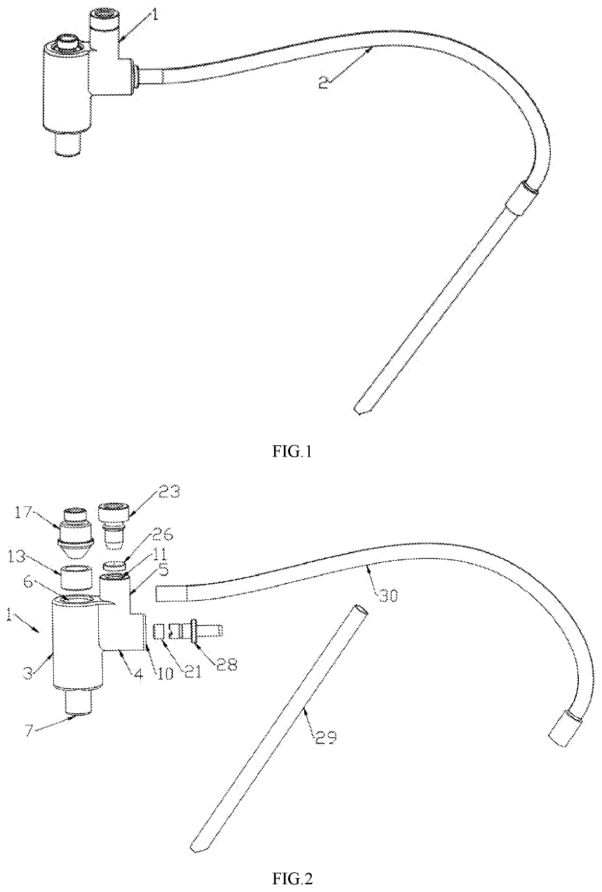

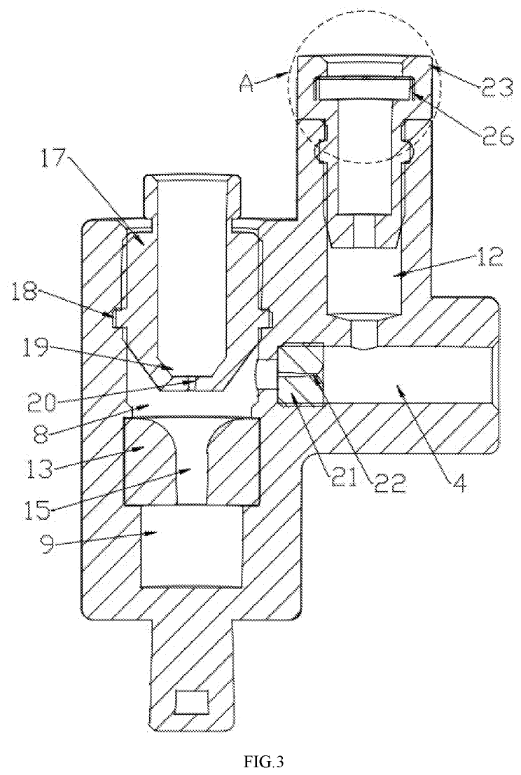

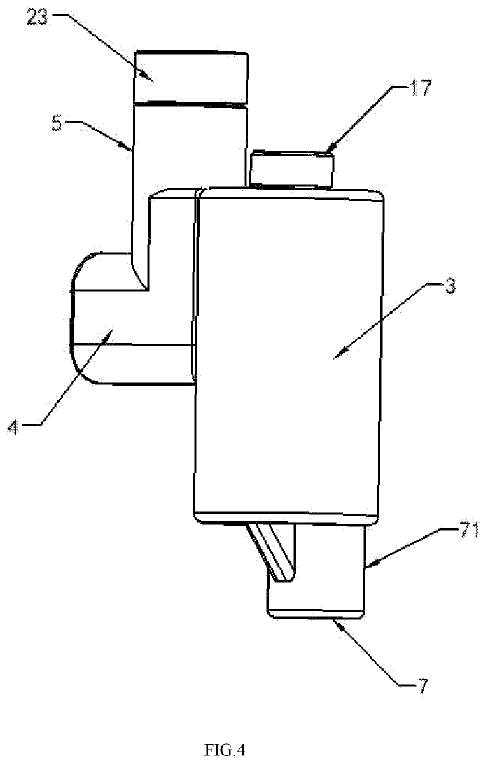

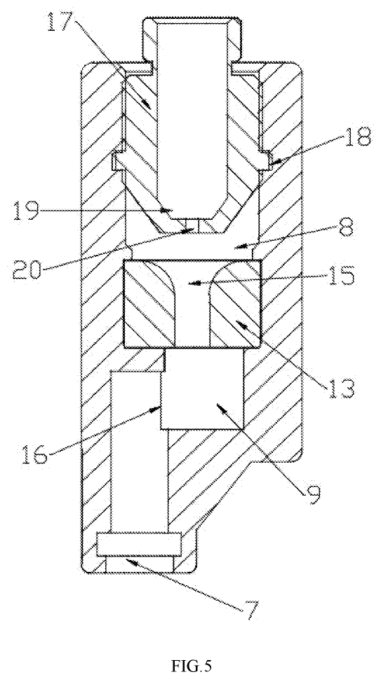

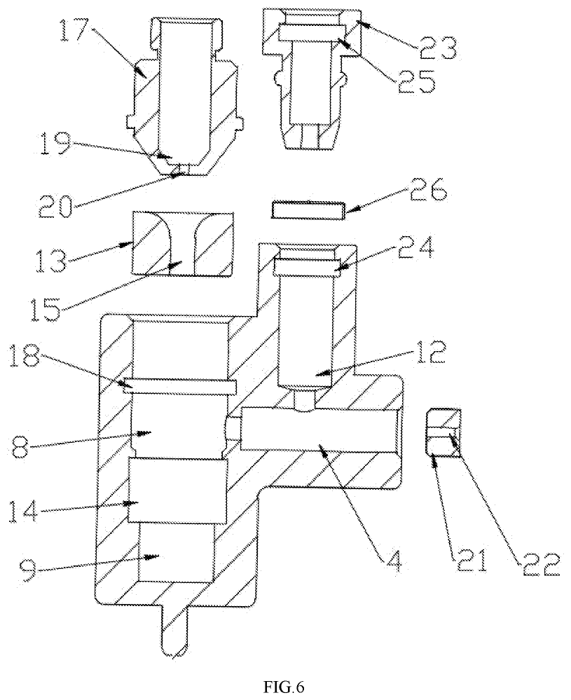

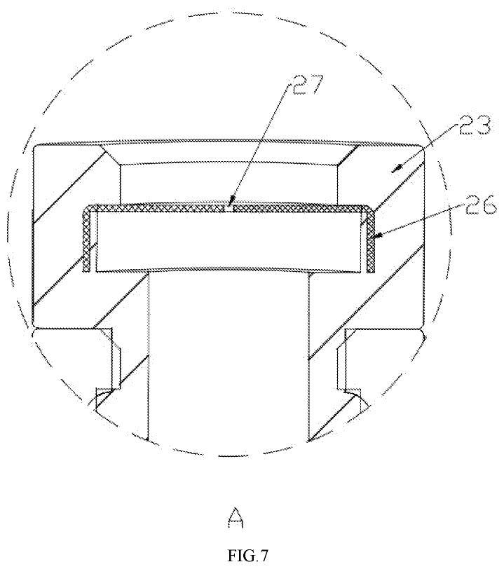

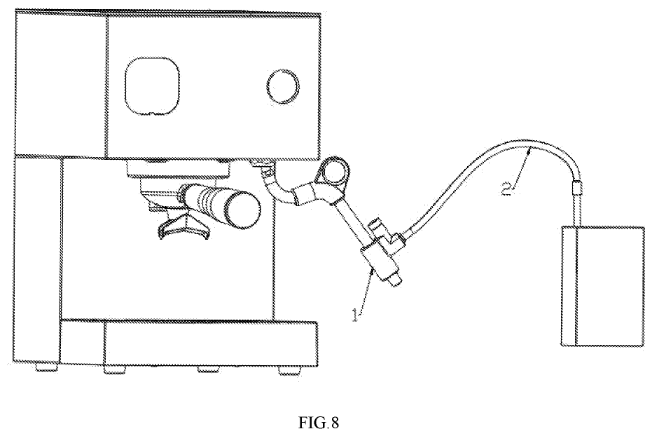

Referring to FIGS. 1-8, a milk-frothing accessory for coffee machines includes a main body 1 and a milk feeding tube 2, wherein the main body 1 has a main passage 3, a milk passage 4 and an air passage 5; a steam inlet 6 and a milk-froth outlet 7 are respectively set on the two ends of the main passage 3, and a blending chamber 8 used to blend steam, milk and air and a frothing chamber 9 used to release slowly milk-froth are further set inside the main passage 3; of the milk passage 4, one end communicates with the blending chamber 8, and the other end is provided with a milk feeding opening 10 connected with the milk feeding tube 2; of the air passage 5, one end communicates with the milk passage 4, and the other end is provided with an air inlet 11; a deceleration chamber 12 used to slow down the flow rate of incoming air is further set in the air passage 5. The milk passage is arranged on one side of the main passage, and the air passage is arranged on one side of the milk passage.

The external steam enters the main passage 3 via the steam inlet 6, while the milk enters the milk passage 4 via the milk feeding pipe 2 by way of passing through the milk feeding opening 10, and is mixed with the air in the air passage 5, thus the steam coming in the main passage 3 and having so higher pressure and speed as to produce a Venturi effect suctions the milk blended with air in the milk passage 4 into the main passage 3, thus the milk is beat and blended into milk-froth, which is discharged via the milk-froth outlet 7.

Therein, a milk ring 21 is set at the end of the milk passage 4 leading to the blending chamber 8, and the milk ring 21 is provided with a funnel-shaped second through hole 22 that communicates the milk passage 4 with the blending chamber 8, in addition, the air inlet 11 of the air passage 5 is provided with an air cap 23, which is embedded in a third groove 24 on the inner wall of the air passage 5; the top of the air cap 23 is exposed at the air inlet 11, and a ventilation piece 26 is embedded in a fourth groove 25 on the inner wall of the top of the air cap 23, further, an air inlet hole 27 is opened on the ventilation piece 26; the deceleration chamber 12 is positioned in the air passage 5 below the bottom of the air cap 23, and a connecting hole is set between any two among the air cap 23, the deceleration chamber 12 and the milk passage 4.

As for a frothing accessory used with coffee machines, the output of milk-froth does not need to be too high, accordingly the venturi effect arising from the steam entering the main passage is not very great. Therefore, the diameter of the second through hole 22 is smaller than that of the milk passage 4, so that this can guarantee that the milk liquid inside the milk passage 4 stably and continuously enters the blending chamber 8. Since the diameter of the second through hole 22 is smaller than that of milk passage 4, the milk liquid in the milk passage 4 slows down its flow rate under the obstruction of the second through hole 22, while the air entering from the air passage 5 on one side of the milk passage 4 is mainly distributed in the space between the milk liquid and the inner wall of the milk passage 4 as the flow rate of the air is generally higher than that of the liquid, thus the incoming air under weak frontal obstruction of the second through hole 22 quickly arrives at and enters the blending chamber 12 through the second through hole 22, but insufficiently blends with the milk liquid during this process.

In this technical solution, after the external air enters the air cap 23 via the air inlet hole 27 on the ventilation piece 26, it first enters the deceleration chamber 12 of the air passage 5 via the connecting hole at the bottom of the air cap 23. Similarly to the reason for achieving a stable and continuous supply of milk liquid in the milk passage 4, because the diameter of the air inlet hole 27 is smaller than that of the air passage 5, the air enters therein at a quite high flow rate. If the air enters the milk passage 4 at such a flow rate, it will further cause a decline for itself to blend with the milk inside the milk passage 4. Therefore, the deceleration chamber 12 is arranged in the air passage 5 below the bottom of the air cap 23, so that the air entering through the air cap 23 slows down its flow rate before entering the milk passage 4 and causes an increase for itself to blend with milk after entering the milk passage 4 at a lower flow rate, thereby realizing pre-blending before entering the blending chamber 12.

The ventilation piece 26 is embedded in the air cap 23, and the air cap 23 is embedded in the air passage 5, thus this design can easily achieve the disassembly and maintenance of the air cap 23 and the ventilation piece 26, in addition, replacing ventilation pieces having air inlet holes in different sizes can change the volume of the coming air, so as to obtain various frothing effects for fine milk-froth.

A receiving ring 13 is arranged between the blending chamber 8 and the frothing chamber 9, and the receiving ring 13 is embedded in the first groove 14 on the inner wall of the main passage 3 and provided with a funnel-shaped first through hole 15 that communicates the blending chamber 8 with the frothing chamber 9. After the steam and the milk blended with air enter the blending chamber 8, they fully collide and mix with each other in the blending chamber under the obstruction of the first through hole 15, then enter the frothing chamber 9 via the first through hole 15. The milk-froth outlet 7 does not lie at the bottom outlet of the frothing chamber 9, but at the end of a milk-froth outlet channel, which is parallel and communicates with the blending chamber 9, and is parallel to the center line of the frothing chamber 9, and a notch 16 that communicates with the milk-froth outlet channel is opened on the side wall of the frothing chamber 9; therefore, under the action of inertia and gravity, the mixture liquid can directly dash to the bottom of the frothing chamber 9, so the bottom of the frothing chamber 9 obstructs the flow of the mixture liquid again, so as to fully release the air mixed in the mixture liquid that slows down its flow rate, thereby beating out richer milk-froth. In order to enable the main body 1 to be in a regular and uniform shape and reduce its thickness as much as possible, the center of the frothing chamber 9 relative to the blending chamber 8 is set to be eccentric.

The steam inlet 6 is provided with a steam spray nozzle 17, of which the top end is exposed outside the steam inlet 6, which is used to connecting the external steam passage, and of which the bottom is embedded in the second groove 18 on the inner wall of the main passage 3, and is a tapered portion 19, and a steam hole 20 that communicates with the blending chamber 8 is opened on the bottom of the tapered portion 19. The purpose of disposing the tapered portion 19 is to gather the steam in the steam nozzle 17, so as to enable it to concentratively and rapidly enter the blending chamber 8 through the steam hole 20, thus the steam more concentratively and rapidly running can better blend with the milk liquid; in addition, the conical side wall of the tapered portion 19 faces the outlet of the milk passage 4 connected to the blending chamber 8, so the milk liquid mixed with air and entering the blending chamber 8 from the milk passage 4 will directly dash on the tapered side wall of the tapered portion 19 and be scattered, so that it can fully blend with the steam in the blending chamber 8 and the air entering with itself.

The milk feeding tube 2 includes a joint 28 and a milk-taking head 29, wherein the joint 28 is connected with the milk feeding opening 10, and an elastic connecting pipe 30 is arranged between the joint 28 and the milk-taking head 29; the milk-taking head 29 can be directly inserted into a bag, a box or bottle containing milk on demands, so as to take milk, thereby cutting down additional attachments such as a milk vessel.

Further, the main body 1 and the air cap 23 are made of silicone, and the receiving ring 13, the steam spray nozzle 17, the milk ring 21 and the ventilation piece 26 are made of stainless steel. Due to the silicone material of the main body 1, it is convenient to install and replace the receiving ring 13, the steam spray nozzle 17 and the milk ring 21, and the stainless steel material of the receiving ring 13, the steam spray nozzle 17, milk ring 21 and the ventilation piece 26 can guarantee the dimensional accuracy attained during processing and the stability during use.

Further, the main passage and the air passage each have a cylindrical outer wall, which intersects with another, and of which the center line is parallel to that of another. The extremity of the milk-froth outlet channel extends out from the cylindrical outer wall of the main passage to form a cylinder body 71 having an outer diameter smaller than the diameter of the cylindrical outer wall of the main passage. The milk passage also has a cylindrical outer wall, which perpendicularly intersects with the cylindrical outer wall of the air passage. The centerlines of these three cylindrical outer walls are located on a first plane, and the centerline of the cylinder body 71 is parallel to the first plane.

1. A milk-frothing accessory for coffee machines, comprising: a main body and a milk feeding tube, wherein said main body has a main passage, a milk passage and an air passage;
a steam inlet and a milk-froth outlet are respectively set on the two ends of said main passage, and a blending chamber used to blend steam, milk and air and a frothing chamber used to release slowly milk-froth are further set inside said main passage;
of said milk passage, one end communicates with said blending chamber, and the other end is provided with a milk feeding opening connected with said milk feeding tube;
of said air passage, one end communicates with said milk passage, and the other end is provided with an air inlet; a deceleration chamber used to slow down the flow rate of incoming air is further set in said air passage; a receiving ring is arranged between said blending chamber and said frothing chamber, and said receiving ring is embedded in a first groove of said main passage and provided with a first through hole that communicates said blending chamber with said frothing chamber;
a center of said frothing chamber relative to said blending chamber is set to be eccentric, and a notch that communicates a said milk-froth outlet channel is opened on a side wall of said frothing chamber and located on the side wall of said frothing chamber close to a centerline of said blending chamber.

2. The milk-frothing accessory according to claim 1, wherein said first through hole is funnel-shaped.

3. The milk-frothing accessory according to claim 2, wherein said steam inlet is provided with a steam spray nozzle,
the top end of said steam spray nozzle is exposed outside said steam inlet and is used to connecting an external steam passage;
the bottom of said steam spray nozzle is embedded in a second groove of said main passage, the bottom of said steam spray nozzle is a tapered portion, a steam hole that communicates with said blending chamber is opened on the bottom of said tapered portion, and the side wall of said tapered portion faces the outlet of said milk passage communicating with said blending chamber;
a milk ring is set at the end of said milk passage leading to said blending chamber, and said milk ring is provided with a funnel-shaped second through hole that communicates said milk passage with said blending chamber.

4. The milk-frothing accessory according to claim 3, wherein said air inlet is provided with an air cap, which is embedded in a third groove on the inner wall of said air passage; said deceleration chamber is positioned in said air passage below the bottom of said air cap, and a connecting hole is set between any two among said air cap, said deceleration chamber and said milk passage.

5. The milk-frothing accessory according to claim 4, wherein the top of said air cap is exposed at said air inlet, a ventilation piece is embedded in a fourth groove on the inner wall of the top of said air cap, and an air inlet hole is opened on said ventilation piece.

6. The milk-frothing accessory according to claim 5, wherein said milk feeding tube comprises a joint and a milk-taking head, said joint is connected with said milk feeding opening, and an elastic connecting pipe is arranged between said joint and said milk-taking head.

7. The milk-frothing accessory according to claim 6, wherein said main body and said air cap are made of silicone, and said receiving ring, said steam spray nozzle, said milk ring and said ventilation piece are made of stainless steel.

8. A coffee machine comprising the milk-frothing accessory according to claim 1.

9. The coffee machine according to claim 8, wherein said main passage and said air passage each have a cylindrical outer wall, which intersects with another, and of which the center line is parallel to that of another, an extremity of said milk-froth outlet channel extends out from said cylindrical outer wall of said main passage to form a cylinder body having an outer diameter smaller than the diameter of said cylindrical outer wall of said main passage, said milk passage also has a cylindrical outer wall, which perpendicularly intersects with said cylindrical outer wall of said air passage, the centerlines of these three cylindrical outer walls are located on a first plane, and the centerline of said cylinder body is parallel to said first plane.
